(19) United States
(12) Patent Application Publication
(10) Pub. No.: US 2019/0102224 A1
(43) Pub. Date: Apr. 4, 2019

(54) TECHNOLOGIES FOR OPPORTUNISTIC ACCELERATION OVERPROVISIONING FOR DISAGGREGATED ARCHITECTURES

(71) Applicant: Intel Corportation, Santa Clara, CA (US)

(72) Inventors: Francesc Guim Bernat, Barcelona (ES); Suraj Prabhakaran, Aachen (DE); Daniel Rivas Barragan, Cologne (DE); Kshitij A. Doshi, Tempe, AZ (US)

(21) Appl. No.: 15/720,453

(22) Filed: Sep. 29, 2017

(51) Int. Cl. G06F 9/48

(52) U.S. Cl. CPC G06F 9/4887; G06F 9/485

(57) ABSTRACT

Technologies for opportunistic acceleration overprovisioning for disaggregated architectures include a compute device. The compute device includes accelerator devices and a management logic unit. The management logic unit is to receive a plurality of job execution requests, each job execution request including a job requested to be accelerated received from an orchestrator server. The management logic unit is also to determine one or more job parameters of each requested job based on the corresponding job execution request, select an accelerator device of the compute device to execute each job based at least in part on the job parameters of the corresponding job, determine, for each job, whether one or more kernels are to be registered on the corresponding accelerator device selected for the corresponding job to enable the corresponding accelerator device to execute the job, register, in response to a determination that the one or more kernels are to be registered, the one or more kernels on the corresponding accelerator device, and schedule, for each accelerator device of the compute device, the kernels of the corresponding accelerator device based on a kernel prediction.

### BACKGROUND

Demand for accelerator devices has continued to increase because the accelerator devices are becoming more important as they may be used in various technological areas, such as machine learning and genomics. Typical architectures for accelerator devices, such as field programmable gate arrays (FPGAs), cryptography accelerators, graphics accelerators, and/or compression accelerators (referred to herein as “accelerator devices,” “accelerators,” or “accelerator resources”) capable of accelerating the execution of a set of operations in a workload (e.g., processes, applications, services, etc.) may allow static assignment of specified amounts of shared resources of the accelerator device (e.g., high bandwidth memory, data storage, etc.) among different portions of the logic (e.g., circuitry) of the accelerator device. Typically, the workload is allocated with the required processor(s), memory, and accelerator device(s) for the duration of the workload. The workload may use its allocated accelerator device at any point of time; however, in many cases, the accelerator devices will remain idle leading to wastage of resources.

### BRIEF DESCRIPTION OF THE DRAWINGS

The concepts described herein are illustrated by way of example and not by way of limitation in the accompanying figures. For simplicity and clarity of illustration, elements illustrated in the figures are not necessarily drawn to scale. Where considered appropriate, reference labels have been repeated among the figures to indicate corresponding or analogous elements.

FIG. 1 is a simplified block diagram of at least one embodiment of a system for overprovisioning of accelerator devices of an accelerator sled through a predictive execution technique;

FIG. 2 is a simplified block diagram of at least one embodiment of an environment that may be established by an accelerator sled of the system of FIG. 1;

FIGS. 3-5 are a simplified flow diagram of at least one embodiment of a method for overprovisioning an accelerator device to execute a job requested to be accelerated that may be executed by the accelerator sled of the system of FIGS. 1 and 2; and

FIGS. 6-7 are simplified diagrams of at least one embodiment of data communications that may sent through the system of FIG. 1 in association with overprovisioning one or more accelerator devices.

### DETAILED DESCRIPTION OF THE DRAWINGS

While the concepts of the present disclosure are susceptible to various modifications and alternative forms, specific embodiments thereof have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described. Additionally, it should be appreciated that items included in a list in the form of “at least one of A, B, and C” can mean (A); (B); (C); (A and B); (A and C); (B and C); or (A, B, and C). Similarly, items listed in the form of “at least one of A, B, or C” can mean (A); (B); (C); (A and B); (A and C); (B and C); or (A, B, and C).

The disclosed embodiments may be implemented, in some cases, in hardware, firmware, software, or any combination thereof. The disclosed embodiments may also be implemented as instructions carried by or stored on one or more transitory or non-transitory machine-readable (e.g., computer-readable) storage media, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features.

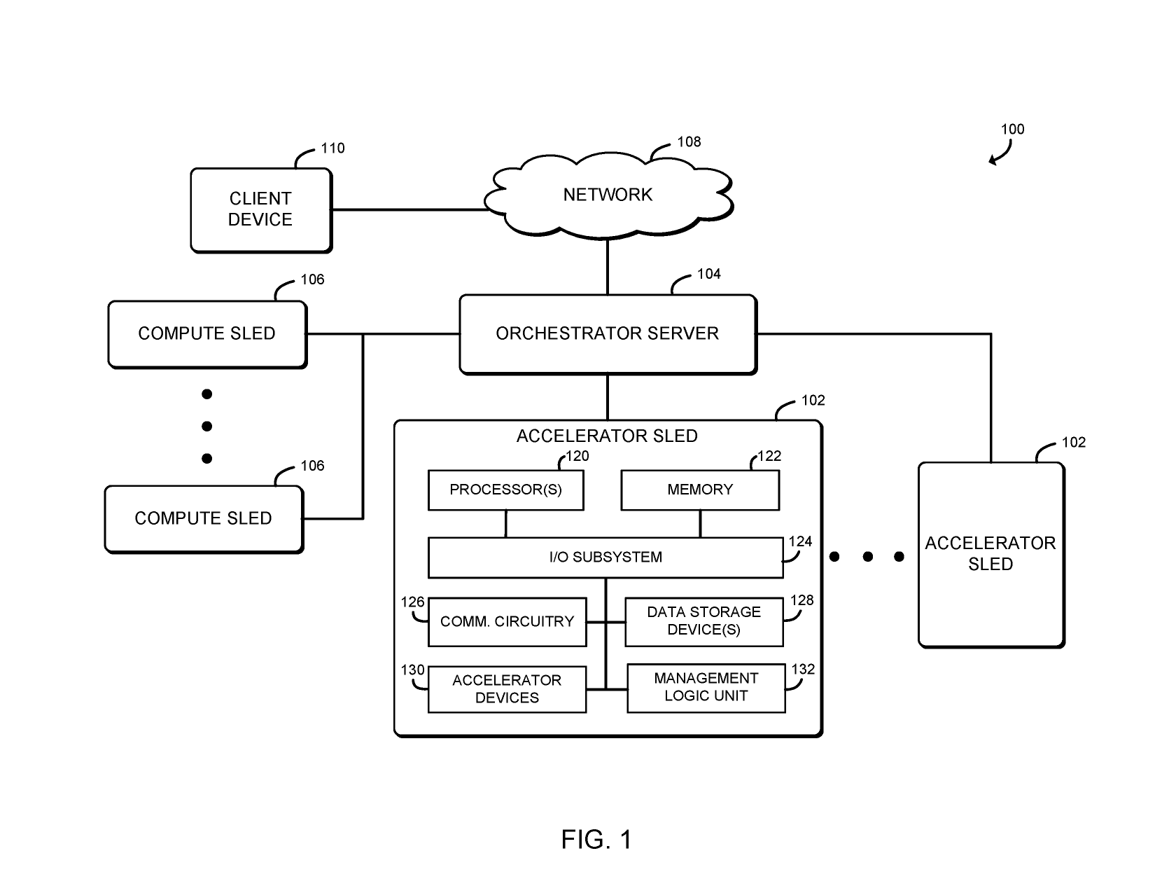

Referring now to FIG. 1, in an illustrative embodiment, a system 100 for overprovisioning of accelerator devices of an accelerator sled 102 includes an orchestrator server 104 in communication with accelerator sleds 102 and compute sleds 106. In use, as described in more detail below, an accelerator sled 102 receives, via the orchestrator server 104, job execution requests with jobs to be accelerated from a compute sled 106 executing different applications. For each job, the accelerator sled 102 determines a kernel (e.g., a set of circuitry and/or executable code usable to implement a set of functions) required to execute the requested job based on the job execution request. The accelerator sled 102 further determines an accelerator device 130 to register the determined kernel and schedules the requested job to the accelerator device 130 for execution. It should be appreciated that multiple kernels may be registered on each accelerator device 130. The accelerator devices 130 are overprovisioned to execute multiple jobs requested to be accelerated by registering multiple kernels from different applications on the accelerator devices 130 to reduce wastage of resources. Additionally, in the illustrative embodiment, the accelerator sled 102 is configured to monitor all kernel submissions and executions and predict the next kernel that is likely to be needed for a job, based on execution patterns of the registered kernels on the accelerator devices 130 of the accelerator sled 102.

It should be understood that in other embodiments, the system 100 may include a different number of accelerator sleds 102, the compute sleds 106, and/or other sleds (e.g., memory sleds or storage sleds). The system 100 may provide compute services (e.g., cloud services) to a client device 110 that is in communication with the system 100 through a network 108. The orchestrator server 104 may support a cloud operating environment, such as OpenStack, and the accelerator sleds 102 and the compute sled 106 may execute one or more applications or processes (i.e., jobs or workloads), such as in virtual machines or containers, on behalf of a user of the client device 110.

The client device 110, the orchestrator server 104, and the sleds of the system 100 (e.g., the accelerator sleds 102 and the compute sled 106) are illustratively in communication via the network 108, which may be embodied as any type of wired or wireless communication network, including global networks (e.g., the Internet), local area networks (LANs) or wide area networks (WANs), cellular networks (e.g., Global System for Mobile Communications (GSM), 3G, Long Term Evolution (LTE), Worldwide Interoperability for Microwave Access (WiMAX), etc.), digital subscriber line (DSL) networks, cable networks (e.g., coaxial networks, fiber networks, etc.), or any combination thereof.

In the illustrative embodiment, each accelerator sled 102 includes one or more processors 120, a memory 122, an input/output (“I/O”) subsystem 124, communication circuitry 126, one or more data storage devices 128, accelerator devices 130, and a management logic unit 132. It should be appreciated that the accelerator sled 102 may include other or additional components, such as those commonly found in a typical computing device (e.g., various input/output devices and/or other components), in other embodiments. Additionally, in some embodiments, one or more of the illustrative components may be incorporated in, or otherwise form a portion of, another component.

The processor 120 may be embodied as any type of processor capable of performing the functions described herein. For example, the processor 120 may be embodied as a single or multi-core processor(s), digital signal processor, microcontroller, or other processor or processing/controlling circuit.

The memory 122 may be embodied as any type of volatile (e.g., dynamic random access memory (DRAM), etc.) or non-volatile memory or data storage capable of performing the functions described herein. Volatile memory may be a storage medium that requires power to maintain the state of data stored by the medium. Non-limiting examples of volatile memory may include various types of random access memory (RAM), such as dynamic random access memory (DRAM) or static random access memory (SRAM). One particular type of DRAM that may be used in a memory module is synchronous dynamic random access memory (SDRAM). In particular embodiments, DRAM of a memory component may comply with a standard promulgated by JEDEC, such as JESD79F for DDR SDRAM, JESD79-2F for DDR2 SDRAM, JESD79-3F for DDR3 SDRAM, JESD79-4A for DDR4 SDRAM, JESD209 for Low Power DDR (LPDDR), JESD209-2 for LPDDR2, JESD209-3 for LPDDR3, and JESD209-4 for LPDDR4 (these standards are available at www.jedec.org). Such standards (and similar standards) may be referred to as DDR-based standards and communication interfaces of the storage devices that implement such standards may be referred to as DDR-based interfaces.

In one embodiment, the memory device is a block addressable memory device, such as those based on NAND or NOR technologies. A memory device may also include future generation nonvolatile devices, such as a three dimensional crosspoint memory device (e.g., Intel 3D XPoint™ memory), or other byte addressable write-in-place nonvolatile memory devices. In one embodiment, the memory device may be or may include memory devices that use chalcogenide glass, multi-threshold level NAND flash memory, NOR flash memory, single or multi-level Phase Change Memory (PCM), a resistive memory, nanowire memory, ferroelectric transistor random access memory (FeTRAM), anti-ferroelectric memory, magnetoresistive random access memory (MRAM) memory that incorporates memristor technology, resistive memory including the metal oxide base, the oxygen vacancy base and the conductive bridge Random Access Memory (CB-RAM), or spin transfer torque (STT)-MRAM, a spintronic magnetic junction memory based device, a magnetic tunneling junction (MTJ) based device, a DW (Domain Wall) and SOT (Spin Orbit Transfer) based device, a thiristor based memory device, or a combination of any of the above, or other memory. The memory device may refer to the die itself and/or to a packaged memory product.

In some embodiments, 3D crosspoint memory (e.g., Intel 3D XPoint™ memory) may comprise a transistor-less stackable cross point architecture in which memory cells sit at the intersection of word lines and bit lines and are individually addressable and in which bit storage is based on a change in bulk resistance. In some embodiments, all or a portion of the memory 122 may be integrated into the processor 120. In operation, the memory 122 may store various data and software used during operation of the accelerator sled 102 such as operating systems, applications, programs, libraries, and drivers.

The memory 122 is communicatively coupled to the processor 120 via the I/O subsystem 124, which may be embodied as circuitry and/or components to facilitate input/output operations with the processor 120, the memory 122, and other components of the accelerator sled 102. For example, the I/O subsystem 124 may be embodied as, or otherwise include, memory controller hubs, input/output control hubs, integrated sensor hubs, firmware devices, communication links (e.g., point-to-point links, bus links, wires, cables, light guides, printed circuit board traces, etc.), and/or other components and subsystems to facilitate the input/output operations. In some embodiments, the I/O subsystem 124 may form a portion of a system-on-a-chip (SoC) and be incorporated, along with one or more of the processor 120, the memory 122, and other components of the accelerator sled 102, on a single integrated circuit chip.

The communication circuitry 126 may be embodied as any communication circuit, device, or collection thereof, capable of enabling communications between the accelerator sled 102 and another compute device (e.g., the orchestrator server 104, a compute sled 106, and/or the client device 110 over the network 108). The communication circuitry 126 may be configured to use any one or more communication technology (e.g., wired or wireless communications) and associated protocols (e.g., Ethernet, Bluetooth®, Wi-Fi®, WiMAX, etc.) to effect such communication.

The data storage 128 may be embodied as any type of device or devices configured for short-term or long-term storage of data such as, for example, memory devices and circuits, memory cards, hard disk drives, solid-state drives, or other data storage devices. In the illustrative embodiment, the accelerator sled 102 may be configured to store registered kernel data, requested job data, and/or prediction data in the data storage 128 as discussed in more detail below.

An accelerator device 130 may be embodied as any type of device configured for executing requested jobs to be accelerated. As such, each accelerator device 130 may be embodied as a single device such as an integrated circuit, an embedded system, a FPGA, a SOC, an ASIC, reconfigurable hardware or hardware circuitry, or other specialized hardware to facilitate performance of the functions described herein. As discussed in detail below, as a job requested to be accelerated is allocated to an accelerator device 130, a corresponding kernel (e.g., a configuration of a set of circuitry and/or executable code usable to implement a set of functions) is registered on the allocated accelerator device 130 to execute the requested job. It should be appreciated that each accelerator sled 102 may include a different number of accelerator devices 130, and each accelerator device 130 may include a different number of kernels registered on the accelerator device 130.

The management logic unit 132 may be embodied as any type of device configured for overprovisioning the accelerator devices 130 to accelerate jobs on behalf of multiple compute sleds 106 to reduce wastage of resources. The management logic unit 132 may determine which accelerator device 130 to execute each requested job based on performance data of each accelerator device 130. For example, the management logic unit 132 may consider an amount of payloads in a queue of each accelerator device 130 to determine which accelerator device 130 has the capability to execute a requested job. In some embodiments, the management logic unit 132 may directly receive the performance data directly from each accelerator device 130 of the accelerator sled 102. It should be appreciated that, in other embodiments, each accelerator device 130 may transmit its performance data (e.g., a queue status) to the orchestrator server 104, and the management logic unit 132 may receive the performance data of one or more accelerator devices 130 from the orchestrator server 104. In some embodiments, the management logic unit 132 may consider hints in a job execution request provided by a compute sled 106. For example, the hints may include an acceleration use pattern (e.g., how much time is required on an accelerator device to execute the requested job).

The management logic unit 132 may further identify a kernel associated with each requested job based on the corresponding job execution request and register the kernel, if not already registered, on a corresponding accelerator device 130 that is to execute the corresponding requested job. The management logic unit 132 may further determine one or more kernel parameters of the kernel based on the corresponding job execution request. For example, the kernel parameters may include a kernel identification (ID) of the kernel required to execute the requested job, an application identification (ID) of an application that is requesting the job to be accelerated, a bit-stream of the requested job, an estimated runtime of the kernel based on previous execution of the kernel, and/or previous timestamps of the kernel. The management logic unit 132 may further determine job parameters of each requested job. The job parameters may include a kernel ID of a kernel associated with the requested job, a payload of the requested job, and/or an estimated runtime of the requested job. The management logic unit 132 may determine the estimated runtime of the requested job as a function of a payload size, previous runs, and/or other information (e.g., hints) received from the job execution request.

Moreover, the management logic unit 132 may further predict one or more next probable kernels to be needed for a job from available applications executing on the compute sled 106. The next probable kernel is selected from all the kernels registered on the accelerator devices 130 of the accelerator sled 102. For example, in some embodiments, the management logic unit 132 may use a prediction of the next probable kernel when determining an accelerator device 130 to execute the requested jobs and/or scheduling and prioritizing the kernels on the corresponding accelerator device 130. Additionally or alternatively, the management logic unit 132 may register the predicted next probable kernel on an available accelerator device 130 prior to receiving a job request, in order to reduce an execution time of the requested job. In some embodiments, the management logic unit 132 may be included in the processor 120.

The client device 110, the orchestrator server 104, and the compute sleds 106 may have components similar to those described with reference to the accelerator sled 102, with the exception that, in the illustrative embodiment, the management logic unit 132 is unique to the accelerator sled 102 and is not included in the client device 110, the orchestrator server 104, or the compute sleds 106. The description of the components of the accelerator sled 102 is equally applicable to the description of components of those devices and is not repeated herein for clarity of the description. Further, it should be appreciated that any of the client device 110, the orchestrator server 104, and the sleds 102, 106 may include other components, sub-components, and devices commonly found in a computing device, which are not discussed above in reference to the accelerator sled 102 and not discussed herein for clarity of the description.

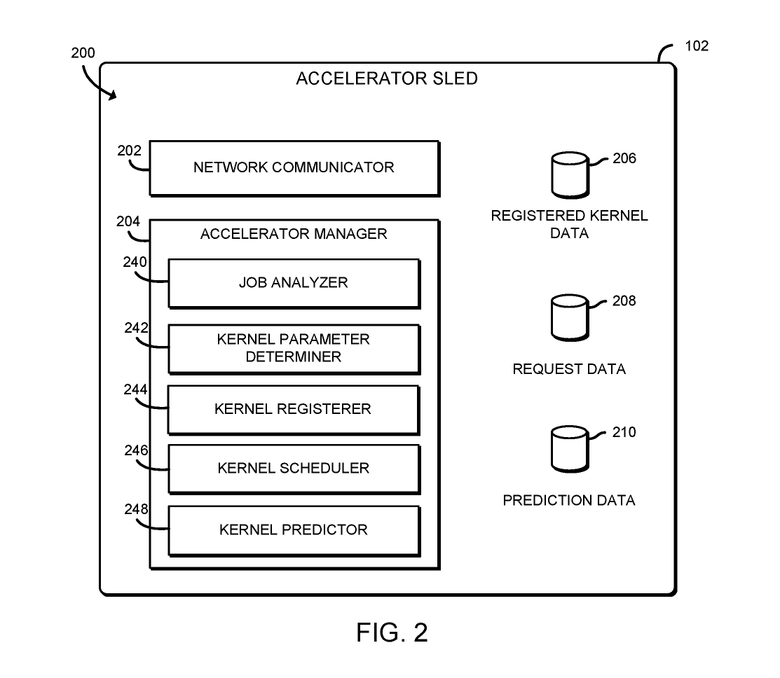

Referring now to FIG. 2, in the illustrative embodiment, each accelerator sled 102 may establish an environment 200 during operation. The illustrative environment 200 includes a network communicator 202 and an accelerator manager 204, which further includes a job analyzer 240, a kernel parameter determiner 242, a kernel registerer 244, a kernel scheduler 246, and a kernel predictor 248. Each of the components of the environment 200 may be embodied as hardware, firmware, software, or a combination thereof. As such, in some embodiments, one or more of the components of the environment 200 may be embodied as circuitry or a collection of electrical devices (e.g., network communicator circuitry 202, accelerator manager circuitry 204, job analyzer circuitry 240, kernel parameter determiner circuitry 242, kernel registerer circuitry 244, kernel scheduler circuitry 246, kernel predictor circuitry 248, etc.). It should be appreciated that, in such embodiments, one or more of the network communicator circuitry 202, the accelerator manager circuitry 204, the job analyzer circuitry 240, the kernel parameter determiner circuitry 242, the kernel registerer circuitry 244, the kernel scheduler circuitry 246, and/or the kernel predictor circuitry 248 may form a portion of one or more of the processor(s) 120, the memory 122, the I/O subsystem 124, the management logic unit 132, and/or other components of the accelerator sled 102.

In the illustrative environment 200, the network communicator 202, which may be embodied as hardware, firmware, software, virtualized hardware, emulated architecture, and/or a combination thereof as discussed above, is configured to facilitate inbound and outbound network communications (e.g., network traffic, network packets, network flows, etc.) to and from the accelerator sled 102, respectively. To do so, the network communicator 202 is configured to receive and process data from one system or computing device (e.g., the orchestrator server 104, a compute sled 106, etc.) and to prepare and send data to a system or computing device (e.g., the orchestrator server 104, a compute sled 106, etc.). Accordingly, in some embodiments, at least a portion of the functionality of the network communicator 202 may be performed by the communication circuitry 126.

The accelerator manager 204, which may be embodied as hardware, firmware, software, virtualized hardware, emulated architecture, and/or a combination thereof as discussed above, is configured to overprovision the accelerator devices 130 to allocate multiple requested jobs across multiple kernels on one or more accelerator devices 130 to reduce wastage of resources. To do so, the accelerator manager 204 includes the job analyzer 240, the kernel parameter determiner 242, the kernel scheduler 246, the kernel registerer 244, and the kernel predictor 248.

The job analyzer 240, which may be embodied as hardware, firmware, software, virtualized hardware, emulated architecture, and/or a combination thereof as discussed above, is configured to determine job parameters of each job requested to be accelerated. The job analyzer 240 may store the requested job in a request database 208. Additionally, the job parameters of the job may be used to determine which accelerator device 130 is to be allocated to execute the requested job. The job parameters may include a kernel ID of a kernel associated with the requested job, a payload of the requested job, and/or an estimated runtime of the requested job. The job analyzer 240 may determine the estimated runtime of the requested job as a function of a payload size, previous runs, or other information received from the job execution request.

The kernel parameter determiner 242, which may be embodied as hardware, firmware, software, virtualized hardware, emulated architecture, and/or a combination thereof as discussed above, is configured to determine one or more kernel parameters of a kernel associated with each requested job based on the corresponding job execution request. For example, as discussed above, the kernel parameters may include a kernel identification (ID) of the kernel required to execute the requested job, an application identification (ID) of an application that is requesting the job to be accelerated, a bit-stream, an estimated runtime of the kernel based on previous execution of the kernel, and/or previous timestamps of the kernel. It should be appreciated that the kernel parameters of the kernel associated with a requested job are used to determine whether to register the kernel on a corresponding accelerator device 130 that is configured to execute the corresponding requested job.

The kernel registerer 244, which may be embodied as hardware, firmware, software, virtualized hardware, emulated architecture, and/or a combination thereof as discussed above, is configured to determine a kernel associated with each requested job based on the corresponding job execution request and register the kernel, if not already registered, on a corresponding accelerator device 130 to execute the corresponding requested job. To register the kernel, the kernel registerer 244 may store the kernel parameters of the corresponding kernel in a registered kernel database 206. As discussed above, the kernel parameters include an application identification (ID) of an application, a kernel identification (ID) of the kernel, a bit-stream, an estimated runtime of the kernel based on previous execution of the kernel, and/or previous timestamps of the kernel.

In some embodiments, the kernel may be new to the accelerator device 130 that is to execute the requested job and has not been registered to any accelerator devices 130 of the accelerator sled 102, the kernel registerer 244 may assign a default number or zero as the estimated runtime and/or the previous timestamps of the kernel and store in the registered kernel database 206. In other embodiments, the kernel may be new to the accelerator device 130 that is to execute the requested job but has been previously registered on other accelerator devices 130. If so, the kernel registerer 244 may acquire the previous executions and/or the previous timestamps of the kernel from other accelerator devices 130 stored in the registered kernel database 206. In yet other embodiments, the kernel may be previously registered on the accelerator device 130, and the kernel registerer 244 may update the existing kernel parameters in the registered kernel database 206.

The kernel scheduler 246, which may be embodied as hardware, firmware, software, virtualized hardware, emulated architecture, and/or a combination thereof as discussed above, is configured to schedule one or more kernels associated with the requested jobs registered on a corresponding accelerator device 130. To do so, the kernel scheduler 246 may consider the performance data of each accelerator device 130 to determine one or more accelerator devices 130 that are available to execute the requested job and are not likely to be congested when assigned to a requested job. For example, the kernel scheduler 246 may determine an amount of payloads in a queue of each accelerator device 130 to determine which accelerator device 130 has capability to execute a requested job. In some embodiments, the kernel scheduler 246 may consider information, such as an acceleration use pattern, included in the job execution request from the compute sled 106 executing the corresponding application.

Additionally, as discussed above, each accelerator device 130 may include multiple registered kernels to execute multiple jobs. For each accelerator device 130, the kernel scheduler 246 may determine all the kernels registered on each accelerator device 130 and schedule the registered kernels on the corresponding accelerator device 130. To do so, the kernel scheduler 246 may prioritize the kernels based on an estimated runtime of each kernel and/or past execution history of each kernel. For example, the kernel scheduler 246 may prioritize and schedule the kernels with a shorter estimated execution time before the kernels with a longer estimated execution time. In some embodiments, the kernel scheduler 246 may prioritize one or more next most probable kernels to receive a job to be accelerated, which is determined by the kernel predictor 248 as discussed below.

The kernel predictor 248, which may be embodied as hardware, firmware, software, virtualized hardware, emulated architecture, and/or a combination thereof as discussed above, is configured to predict a next probable kernel to receive a job to be accelerated from an available application. The next probable kernel is selected from all the kernels registered on the accelerator devices 130 of the accelerator sled 102. In some embodiments, the kernel predictor 248 may predict a list of next probable kernels that are likely to receive a job to be accelerated. The kernel predictor 248 may store the prediction data in a prediction database 210 for other components of the accelerator sled 102 to access the prediction data. For example, in some embodiments, the kernel scheduler 246 may use the predicted list of next probable kernels when determining an accelerator device 130 to execute the requested jobs and/or scheduling and prioritizing the kernels on the corresponding accelerator device 130. Additionally or alternatively, the kernel registerer 244 may also access the prediction database 210 to register the predicted next probable kernel on an available accelerator device 130 prior to receiving a requested job, to reduce the total amount of time needed to execute a requested job.

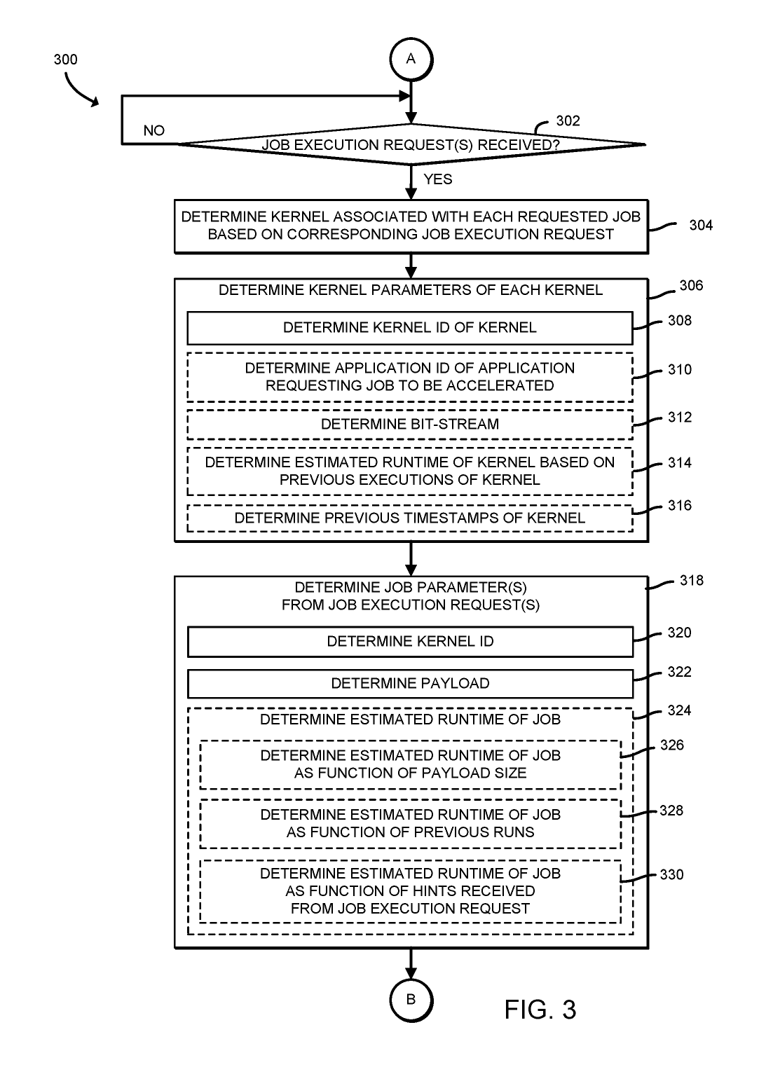

Referring now to FIGS. 3-5, in use, the accelerator sled 102 may execute a method 300 for overprovisioning the accelerator devices 130 to execute multiple jobs with multiple kernels on the accelerator devices 130, to reduce wastage of resources. The method 300 begins with block 302 in which the accelerator sled 102 determines whether one or more job execution requests have been received (e.g., from the orchestrator server 104). Each job execution request includes a job requested to be accelerated from a compute sled 106 executing one or more applications. In the illustrative embodiment, the accelerator sled 102 receives a job execution request indirectly from the compute sled 106 via the orchestrator server 104. It should be appreciated that, in some embodiments, the accelerator sled 102 may receive a job execution request directly from a compute sled 106. In other embodiments, the processor 120 of the accelerator sled 102 may internally generate a job execution request with a job to be accelerated. If the accelerator sled 102 determines that a job execution request has not been received, the method 300 loops back to block 302 to continue monitoring for a job execution request. If, however, the accelerator sled 102 determines that a job execution request has been received, the method 300 advances to block 304.

In block 304, the accelerator sled 102 determines a kernel associated with each requested job based on the corresponding job execution request. As discussed above, a kernel is a set of circuitry and/or executable code usable to implement a set of functions required for executing the requested job.

In block 306, the accelerator sled 102 determines kernel parameters of each kernel associated with the corresponding requested job. To do so, the accelerator sled 102 determines a kernel identification (ID) of each kernel in block 308. It should be appreciated that the kernel ID may be used to determine whether the kernel has been registered to an accelerator device 130 as discussed below. In block 310, the accelerator sled 102 may determine an application identification (ID) of an application that is requesting the job to be accelerated. It should be appreciated that the application ID may be used to predict which kernel is likely to receive (e.g., likely to be needed for) an upcoming job as discussed below. In block 312, the accelerator sled 102 may determine a bit-stream of the requested job. In block 314, the accelerator sled 102 may determine an estimated runtime of the kernel based on previous executions of the kernel. If the kernel has not previously executed a job, the accelerator sled 102 may assign zero as the estimated runtime. In block 316, the accelerator sled 102 may determine previous timestamps of the kernel. If the kernel has not previously executed a job, the accelerator sled 102 may assign zero as the previous time stamp. It should be appreciated that, in some embodiments, if the accelerator sled 102 determines that the kernel has not been previously registered to the accelerator device 130 but has been previously registered on other accelerator device 130, the accelerator sled 102 may acquire the previous executions and/or the previous timestamps of the kernel from the other accelerator devices 130.

In block 318, the accelerator sled 102 determines one or more job parameters of the requested job from the job execution request. For example, the accelerator sled 102 determines a kernel ID of the kernel associated with the requested job in block 320 and determines a payload of the requested job in block 322. It should be appreciated that the size of the payload may be used to determine which accelerator device 130 to allocate to the requested job.

In block 324, the accelerator sled 102 may determine an estimated runtime of the requested job. To do so, the accelerator sled 102 may determine an estimated runtime of the requested job as a function of a payload size in block 326. Alternatively, the accelerator sled 102 may determine an estimated runtime of the requested job as a function of previous runs in block 328. As discussed above, in some embodiments, if the accelerator sled 102 determines that the kernel has not been previously registered to the accelerator device 130 but has been previously registered on another accelerator device 130, the accelerator sled 102 may acquire the previous runs of the kernel from other accelerator devices 130 to determine an estimated runtime of the requested job (e.g., as a function of the previous runs).

Additionally or alternatively, in block 330, the accelerator sled 102 may determine an estimated runtime of the requested job as a function of other information or hints embedded in the job execution request (e.g., provided in the job execution request by the compute sled 106). For example, the job execution request may include an accelerator use pattern for the requested job that may indicate the time required to be reserved on an accelerator device 130 to execute the requested job.

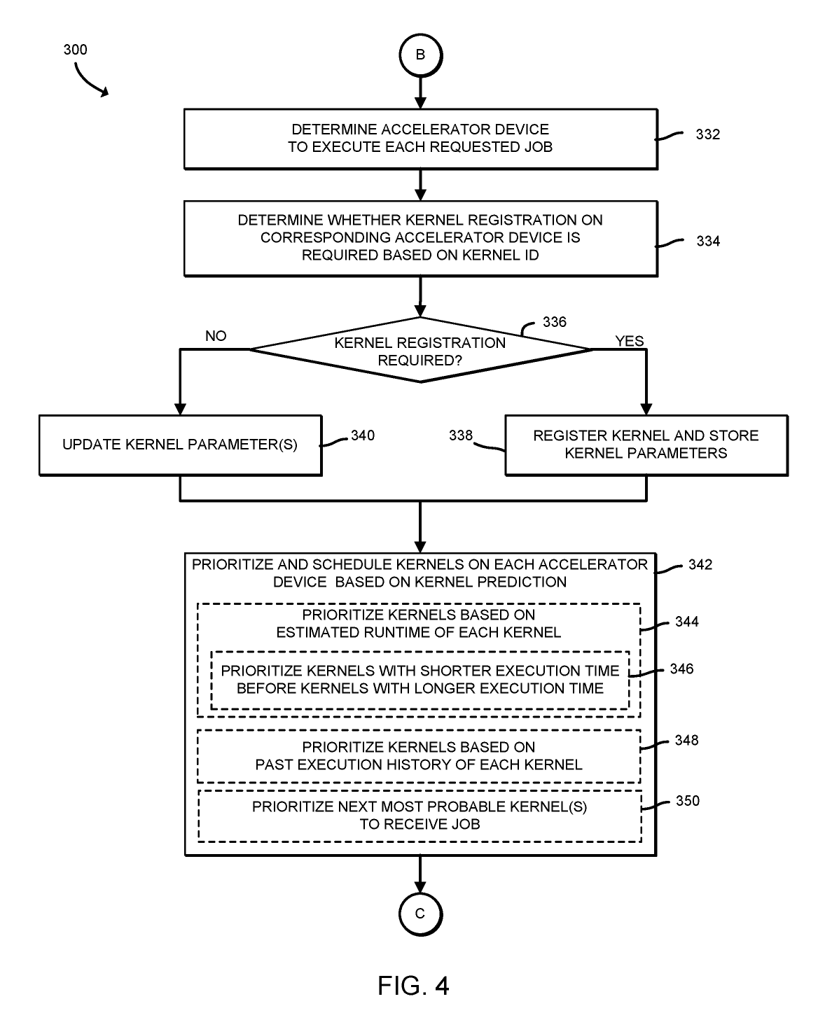

Subsequently, in block 332 shown in FIG. 4, the accelerator sled 102 determines an accelerator device to execute each requested job. To do so, for each requested job, the accelerator sled 102 may consider the job parameters of the requested job and/or the kernel parameters of the kernel associated with the requested job to determine an accelerator device that is not likely to be congested when assigned to the requested job.

In block 334, the accelerator sled 102 determines whether a registration of the kernel associated with the requested job is required on the corresponding accelerator device 130. To do so, the accelerator sled 102 determines whether the kernel has been previously registered on the accelerator device 130, based on the kernel ID of the kernel. If the accelerator sled 102 determines that the kernel registration is required in block 336, the method 300 advances to block 338 in which the accelerator sled 102 registers the kernel on the accelerator device 130 and stores the kernel parameters of the kernel in the registered kernel database 206 and proceeds to block 342. If, however, the accelerator sled 102 determines that the kernel has been previously registered on the accelerator device 130, the method 300 advances to block 340 in which the accelerator sled 102 updates the kernel parameters of the kernel in the registered kernel database 206 and proceeds to block 342.

In block 342, for each accelerator device 130, the accelerator sled 102 prioritizes and schedules the kernels that are associated with the requested jobs and that are registered on the accelerator device 130, based on a kernel prediction, to efficiently execute the requested jobs. For example, in block 344, the accelerator sled 102 may prioritize the kernels registered on the accelerator device 130 based on the estimated runtime of each kernel. To do so, in block 346, the accelerator sled 102 may prioritize kernels with shorter execution time before kernels with longer execution time. Additionally or alternatively, in block 348, the accelerator sled 102 may prioritize the kernels on each accelerator device 130 based on the past execution history of each kernel. Additionally or alternatively, in block 350, the accelerator sled 102 may prioritize the kernels on each accelerator device 130 that have higher probability of being the next kernel to receive (e.g., be needed for) a job to be accelerated.

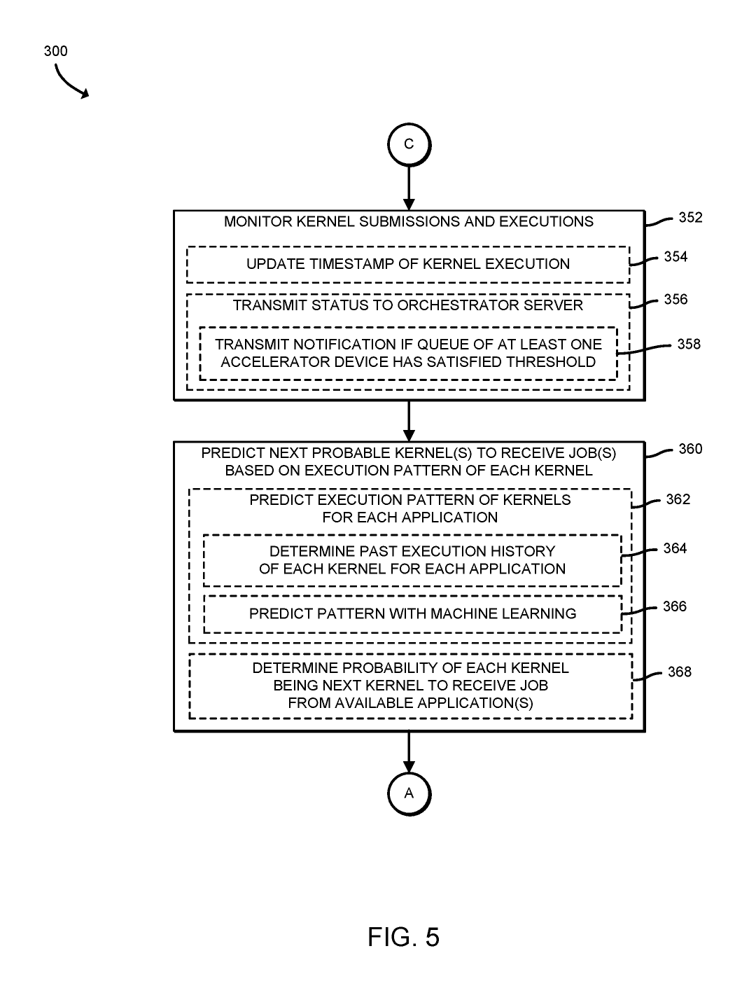

Subsequently, in block 352 in FIG. 5, the accelerator sled 102 monitors kernel submissions and executions on each accelerator device 130. To do so, in block 352, the accelerator sled 102 may update the timestamp of the kernel execution after the execution of the requested job. As discussed above, the timestamps of previous kernel executions of each kernel may be used to determine an execution pattern of the corresponding kernel. Additionally, in block 356, the accelerator sled 102 may transmit the status (e.g., performance data) of each kernel to the orchestrator server 104. To do so, the accelerator sled 102 may transmit a notification if a queue of at least one accelerator device 130 has satisfied a predefined threshold (e.g., the queue is 100% full) in block 358. It should be appreciated that, in some embodiments, the orchestrator server 104 may indicate not to allocate, in response to a receipt of the notification, a subsequent job to that accelerator device 130 until the queue of the accelerator device 130 has a predefined amount of capacity to receive more jobs in the queue.

In block 360, the accelerator sled 102 predicts one or more next probable kernels to be needed based on the execution patterns of the registered kernels. To do so, in block 362, the accelerator sled 102 may predict the execution pattern of the kernels for each application based on the application ID. For example, the accelerator sled 102 may determine past execution history of each kernel for each application in block 364. In some embodiments, the accelerator sled 102 may predict the execution pattern for each kernel with machine learning in block 366. Additionally or alternatively, in block 368, the accelerator sled 102 may determine a probability of each kernel being the next kernel to receive a job to be accelerated from one or more available applications (e.g., the applications that are presently being executed on the compute sled(s) 106). Subsequently, the method 300 loops back to block 302 to continue monitoring for job execution requests.

It should be appreciated that the accelerator sled 102 may use the predicted list of next probable kernels when determining an accelerator device 130 to execute the requested jobs in block 332 and/or scheduling and prioritizing the kernels on the corresponding accelerator device 130 in block 350. Additionally or alternatively, accelerator sled 102 may register the predicted next probable kernel on an available accelerator device 130 prior to receiving a requested job to reduce time to execute a requested job.

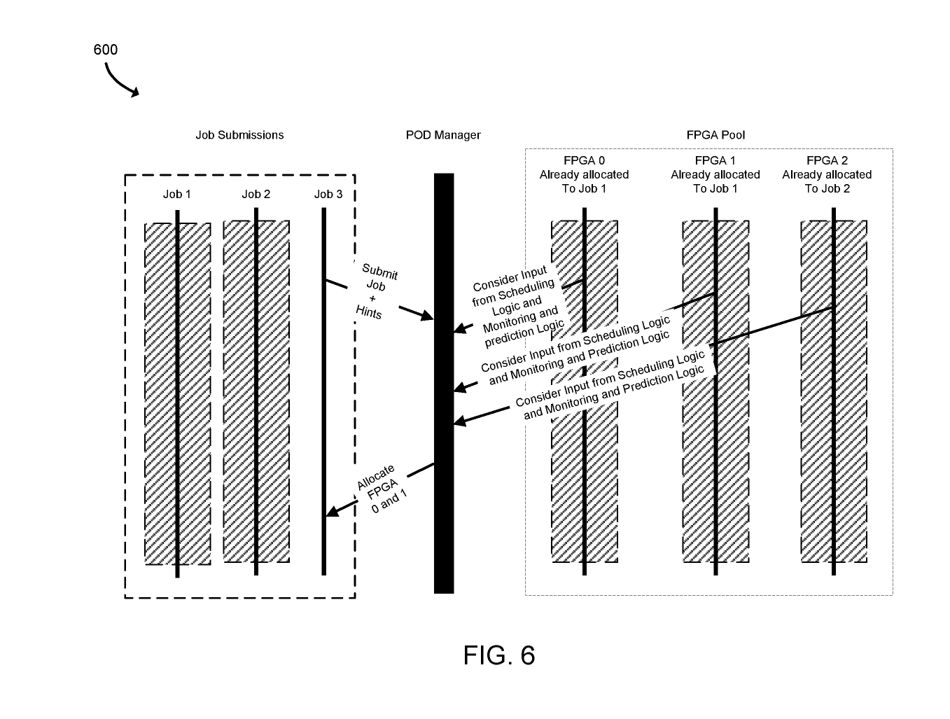

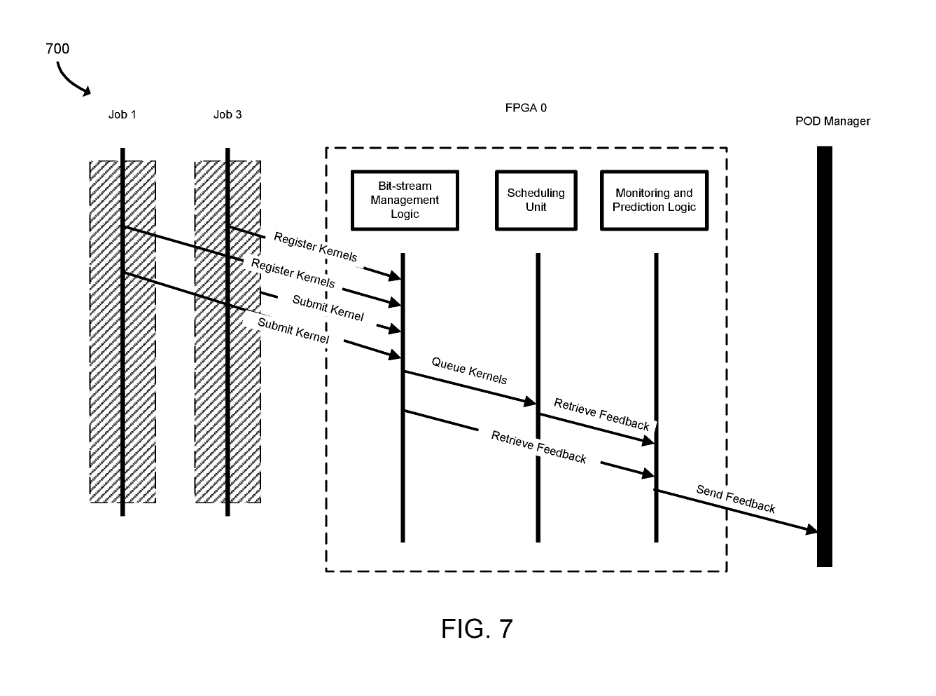

Referring now to FIGS. 6 and 7, illustrative diagrams 600, 700 illustrate an exemplary process of overprovisioning of the accelerator devices 130 (illustrated as FPGAs) to allocate a new job requested to be accelerated. The illustrative diagram 600 includes the FPGAs (e.g., the accelerator devices 130) and a POD manager (e.g., the management logic unit 132 of the accelerator sled 102). In some embodiments, the POD manager may be the orchestrator server 104. As illustrated in FIG. 6, the compute sled 106 submits a new job execution request that includes Job 3 requested to be accelerated. When a requested Job 3 is submitted to the POD manager, the job execution request also provides hints such as FPGA usage patterns of Job 3. The POD manager uses the hints and inputs (e.g., the performance data) from the FPGAs to determine an FPGA to execute Job 3. In the illustrative diagram 700, shown in FIG. 7, each FPGA includes a scheduling logic (e.g., the kernel scheduler 246) and a monitoring and prediction logic (e.g., the kernel predictor 248). In this example, the POD manager determines that FPGA 0 and FPGA 1 are already allocated to Job 1 and FPGA 2 is already allocated to Job 2. Based on the inputs from the FPGAs and the new job execution request, the POD manager may determine to overprovision FPGA 0 and FPGA 1 to Job 3. It should be appreciated that more than one kernel may be associated with a requested job, each of which can be registered on a different FPGA. For example, as shown in FIG. 6, both FPGA 0 and FPGA 1 are allocated to Job 1.

As the jobs begin, the kernels associated with the jobs are registered on the allocated FPGA(s). For example, as illustrated in FIG. 7, each kernel associated with Job 1 and Job 3, each of which is allocated to FPGA 0, is registered on FPGA 0. The illustrated FPGA 0 includes a bit-stream management logic (e.g., the job analyzer 240 and/or the kernel parameter determiner 242), a scheduling unit (e.g., the kernel scheduler 246), and a monitoring and prediction logic (e.g., the kernel predictor 248). The bit-stream management logic of FPGA 0 is configured to accept the kernel registration and execution requests from the applications. To do so, the bit-stream management logic may determine one or more job parameters of each job and one or more kernel parameters of the corresponding kernel. Subsequently, the bit-stream management logic enqueues the requested job (Job 1 and Job 3) on each queue of the corresponding kernel.

The scheduling unit of FPGA 0 is configured to schedule the kernels associated with Job 1 and Job 3 on FPGA 0 by determining all the kernels registered on FPGA 0 and scheduling the registered kernels on FPGA 0. To do so, the scheduling unit may prioritize the kernels based on an estimated runtime of each kernel and/or past execution history of each kernel. For example, the scheduling unit may prioritize and schedule the kernels with a shorter estimated execution time before the kernels with a longer estimated execution time. In some embodiments, the scheduling unit may prioritize one or more next most probable kernels to receive a job to be accelerated, which is determined by the monitoring and prediction logic as discussed below.

The monitoring and prediction logic of FPGA 0 receives feedback from the bit-stream management logic and the scheduling unit. The monitoring and prediction logic is configured to predict a next probable kernel to receive a job to be accelerated from an available application. The next probable kernel is selected from all kernels registered on all FPGAs of the accelerator sled 102. In some embodiments, the monitoring and prediction logic may predict a list of next probable kernels that are likely to receive a job to be accelerated. In other embodiments, the next probable kernel may be selected from all kernels registered on FPGA 0 of the accelerator sled 102. The monitoring and prediction logic may store the prediction data in a prediction database 210 for other components of the accelerator sled 102 to access the prediction data. For example, in some embodiments, the scheduling unit may use the predicted list of next probable kernels when determining which FPGA to execute the requested jobs and/or scheduling and prioritizing the kernels on the corresponding FPGA. Additionally or alternatively, the bit-stream management logic may also access the prediction database 210 to register the predicted next probable kernel on an available FPGA prior to receiving a requested job, to reduce the amount of time needed to execute a requested job. Subsequently, the monitoring and prediction logic sends feedback to the POD manager. For example, the feedback may include a notification that a queue of the corresponding kernel has satisfied a predefined threshold.

### EXAMPLES

Illustrative examples of the technologies disclosed herein are provided below. An embodiment of the technologies may include any one or more, and any combination of, the examples described below.

Example 1 includes a compute device comprising a plurality of accelerator devices; and a management logic unit to receive a plurality of job execution requests, each job execution request including a job requested to be accelerated received from an orchestrator server; determine one or more job parameters of each requested job based on the corresponding job execution request; select an accelerator device of the compute device to execute each job based at least in part on the job parameters of the corresponding job; determine, for each job, whether one or more kernels are to be registered on the corresponding accelerator device selected for the corresponding job to enable the corresponding accelerator device to execute the job; register, in response to a determination that the one or more kernels are to be registered, the one or more kernels on the corresponding accelerator device; and schedule, for each accelerator device of the compute device, the kernels of the corresponding accelerator device based on a kernel prediction.

Example 2 includes the subject matter of Example 1, and wherein to determine whether one or more kernels are to be registered on the corresponding accelerator device comprises to determine whether each kernel associated with a corresponding requested job has been previously registered on the compute device.

Example 3 includes the subject matter of any of Examples 1 and 2, and wherein each of the plurality of the accelerator devices is a field programmable gate array (FPGA) and wherein to register the one or more kernels on the corresponding accelerator device comprises to register the one or more kernels on the corresponding FPGA and determine one or more kernel parameters of each kernel.

Example 4 includes the subject matter of any of Examples 1-3, and wherein to determine the one or more kernel parameters of each kernel comprises to determine an application identification (ID) of an application requesting the requested job to be accelerated.

Example 5 includes the subject matter of any of Examples 1-4, and wherein to determine the one or more kernel parameters of each kernel comprises to determine a kernel identification (ID) of each kernel.

Example 6 includes the subject matter of any of Examples 1-5, and wherein to determine the one or more kernel parameters of each kernel comprises to determine a bit-stream.

Example 7 includes the subject matter of any of Examples 1-6, and wherein to determine the one or more kernel parameters of each kernel comprises to determine an estimated runtime of each kernel based on one or more previous executions of each kernel.

Example 8 includes the subject matter of any of Examples 1-7, and wherein to determine the one or more kernel parameters of each kernel comprises to determine one or more previous timestamps of each kernel.

Example 9 includes the subject matter of any of Examples 1-8, and wherein to determine the one or more job parameters of each requested job based on the corresponding job execution request comprises to determine a kernel identification (ID) of the kernel associated with each requested job.

Example 10 includes the subject matter of any of Examples 1-9, and wherein to determine the one or more job parameters of each requested job based on the corresponding job execution request comprises to determine a payload of each requested job.

Example 11 includes the subject matter of any of Examples 1-10, and wherein to determine the one or more job parameters of each requested job based on the corresponding job execution request comprises to determine an estimated runtime of each requested job.

Example 12 includes the subject matter of any of Examples 1-11, and wherein to determine the estimated runtime of each requested job comprises to determine an estimated runtime of each requested job as a function of a payload size of the corresponding requested job.

Example 13 includes the subject matter of any of Examples 1-12, and wherein to determine the estimated runtime of the requested job comprises to determine an estimated runtime of each requested job as a function of previous runs of the corresponding requested job.

Example 14 includes the subject matter of any of Examples 1-13, and wherein to determine the estimated runtime of the requested job comprises to determine an estimated runtime of each requested job as a function of hints received from the job execution request.

Example 15 includes the subject matter of any of Examples 1-14, and wherein the hints comprise a usage pattern of one or more accelerator devices.

Example 16 includes the subject matter of any of Examples 1-15, and wherein to schedule the kernels registered on the accelerator device of the compute device comprises to prioritize the kernels registered on the compute device based on the kernel prediction.

Example 17 includes the subject matter of any of Examples 1-16, and wherein to prioritize the kernels registered on the compute device based on the kernel prediction comprises to prioritize the kernels based on an estimated runtime of each kernel.

Example 18 includes the subject matter of any of Examples 1-17, and wherein to prioritize the kernels based on the estimated runtime of each kernel comprises to prioritize a kernel with a shorter execution time before a kernel with a longer execution time.

Example 19 includes the subject matter of any of Examples 1-18, and wherein to prioritize the kernels registered on the compute device based on the kernel prediction comprises to prioritize the kernels based on a past execution history of each kernel.

Example 20 includes the subject matter of any of Examples 1-19, and wherein to prioritize the kernels registered on the compute device based on the kernel prediction comprises to prioritize a next most probable kernel to receive a job to be accelerated.

Example 21 includes the subject matter of any of Examples 1-20, and wherein the management logic unit is further to monitor kernel submission and execution of each job execution request on a corresponding kernel.

Example 22 includes the subject matter of any of Examples 1-21, and wherein to monitor kernel submission and execution of each job execution request on the corresponding kernel comprises to update a timestamp of the kernel execution for the corresponding kernel.

Example 23 includes the subject matter of any of Examples 1-22, and wherein to monitor kernel submission and execution of each job execution request on the corresponding kernel comprises to transmit a status of the corresponding kernel to the orchestrator server.

Example 24 includes the subject matter of any of Examples 1-23, and wherein to transmit the status of the corresponding kernel to the orchestrator server comprises to transmit a notification that a queue of the corresponding kernel has satisfied a predefined threshold.

Example 25 includes the subject matter of any of Examples 1-24, and wherein the management logic unit is further to predict a next probable kernel from the kernels registered on the accelerator devices of the compute device to receive a job to be accelerated based on an execution pattern of each kernel.

Example 26 includes the subject matter of any of Examples 1-25, and wherein to predict a next probable kernel from the kernels registered on the accelerator devices of the compute device comprises to predict an execution pattern of each kernel registered on the accelerator devices of the compute device for each application.

Example 27 includes the subject matter of any of Examples 1-26, and wherein to predict an execution pattern comprises to determine a past execution history of each kernel for each application.

Example 28 includes the subject matter of any of Examples 1-27, and wherein to predict an execution pattern comprises to predict patterns of the kernels with machine learning.

Example 29 includes the subject matter of any of Examples 1-28, and wherein to predict a next probable kernel comprises to determine a probability of each kernel being a next kernel to receive a job from one or more available applications.

Example 30 includes a method for overprovisioning accelerator devices of a compute device, the method comprising receiving, by the compute device, a plurality of job execution requests, each job execution request including a job requested to be accelerated received from an orchestrator server; determining, by the compute device, one or more job parameters of each requested job based on the corresponding job execution request; selecting, by the compute device, an accelerator device of the compute device to execute each job based at least in part on the job parameters of the corresponding job; determining, by the compute device and for each job, whether one or more kernels are to be registered on the corresponding accelerator device selected for the corresponding job to enable the corresponding accelerator device to execute the job; registering, by the compute device and in response to a determination that the one or more kernels are to be registered, the one or more kernels on the corresponding accelerator device; and scheduling, for each accelerator device of the compute device and by the compute device, the kernels of the corresponding accelerator device based on a kernel prediction.

Example 31 includes the subject matter of Example 30, and wherein determining whether one or more kernels are to be registered on the corresponding accelerator device comprises determining whether each kernel associated with a corresponding requested job has been previously registered on the compute device.

Example 32 includes the subject matter of any of Examples 30 and 31, and wherein each of the plurality of the accelerator devices is a field programmable gate array (FPGA) and wherein registering the one or more kernels on the corresponding accelerator device comprises registering the one or more kernels on the corresponding FPGA and determining one or more kernel parameters of each kernel.

Example 33 includes the subject matter of any of Examples 30-32, and wherein determining the one or more kernel parameters of each kernel comprises determining an application identification (ID) of an application requesting the requested job to be accelerated.

Example 34 includes the subject matter of any of Examples 30-33, and wherein determining the one or more kernel parameters of each kernel comprises determining a kernel identification (ID) of each kernel.

Example 35 includes the subject matter of any of Examples 30-34, and wherein determining the one or more kernel parameters of each kernel comprises determining a bit-stream.

Example 36 includes the subject matter of any of Examples 30-35, and wherein determining the one or more kernel parameters of each kernel comprises determining an estimated runtime of each kernel based on one or more previous executions of each kernel.

Example 37 includes the subject matter of any of Examples 30-36, and wherein determining the one or more kernel parameters of each kernel comprises determining one or more previous timestamps of each kernel.

Example 38 includes the subject matter of any of Examples 30-37, and wherein determining the one or more job parameters of each requested job based on the corresponding job execution request comprises determining a kernel identification (ID) of the kernel associated with each requested job.

Example 39 includes the subject matter of any of Examples 30-38, and wherein determining the one or more job parameters of each requested job based on the corresponding job execution request comprises determining a payload of each requested job.

Example 40 includes the subject matter of any of Examples 30-39, and wherein determining the one or more job parameters of each requested job based on the corresponding job execution request comprises determining an estimated runtime of each requested job.

Example 41 includes the subject matter of any of Examples 30-40, and wherein determining the estimated runtime of each requested job comprises determining an estimated runtime of each requested job as a function of a payload size of the corresponding requested job.

Example 42 includes the subject matter of any of Examples 30-41, and wherein determining the estimated runtime of the requested job comprises determining an estimated runtime of each requested job as a function of previous runs of the corresponding requested job.

Example 43 includes the subject matter of any of Examples 30-42, and wherein determining the estimated runtime of the requested job comprises determining an estimated runtime of each requested job as a function of hints received from the job execution request.

Example 44 includes the subject matter of any of Examples 30-43, and wherein the hints comprises a usage pattern of one or more accelerator devices.

Example 45 includes the subject matter of any of Examples 30-44, and wherein scheduling the kernels registered on the accelerator device of the compute device comprises prioritizing the kernels registered on the compute device based on the kernel prediction.

Example 46 includes the subject matter of any of Examples 30-45, and wherein prioritizing the kernels registered on the compute device based on the kernel prediction comprises prioritizing the kernels based on an estimated runtime of each kernel.

Example 47 includes the subject matter of any of Examples 30-46, and wherein prioritizing the kernels based on the estimated runtime of each kernel comprises prioritizing a kernel with a shorter execution time before a kernel with a longer execution time.

Example 48 includes the subject matter of any of Examples 30-47, and wherein prioritizing the kernels registered on the compute device based on the kernel prediction comprises prioritizing the kernels based on a past execution history of each kernel.

Example 49 includes the subject matter of any of Examples 30-48, and wherein prioritizing the kernels registered on the compute device based on the kernel prediction comprises prioritizing a next most probable kernel to receive a job to be accelerated.

Example 50 includes the subject matter of any of Examples 30-49, and further including monitoring, by the compute device, kernel submission and execution of each job execution request on a corresponding kernel.

Example 51 includes the subject matter of any of Examples 30-50, and wherein monitoring kernel submission and execution of each job execution request on the corresponding kernel comprises updating a timestamp of the kernel execution for the corresponding kernel.

Example 52 includes the subject matter of any of Examples 30-51, and wherein monitoring kernel submission and execution of each job execution request on the corresponding kernel comprises transmitting a status of the corresponding kernel to the orchestrator server.

Example 53 includes the subject matter of any of Examples 30-52, and wherein transmitting the status of the corresponding kernel to the orchestrator server comprises transmitting a notification that a queue of the corresponding kernel has satisfied a predefined threshold.

Example 54 includes the subject matter of any of Examples 30-53, and further including predicting, by the compute device, a next probable kernel from the kernels registered on the accelerator devices of the compute device to receive a job to be accelerated based on an execution pattern of each kernel.

Example 55 includes the subject matter of any of Examples 30-54, and wherein predicting a next probable kernel from the kernels registered on the accelerator devices of the compute device comprises predicting an execution pattern of each kernel registered on the accelerator devices of the compute device for each application.

Example 56 includes the subject matter of any of Examples 30-55, and wherein predicting an execution pattern comprises determining a past execution history of each kernel for each application.

Example 57 includes the subject matter of any of Examples 30-56, and wherein predicting an execution pattern comprises predicting patterns of the kernels with machine learning.

Example 58 includes the subject matter of any of Examples 30-57, and wherein predicting a next probable kernel comprises determining a probability of each kernel being a next kernel to receive a job from one or more available applications.

Example 59 includes one or more machine-readable storage media comprising a plurality of instructions stored thereon that, in response to being executed, cause a compute device to perform the method of any of Examples 30-58.

Example 60 includes a compute device comprising means for performing the method of any of Examples 30-58.

Example 61 includes a compute device comprising a plurality of accelerator devices; a network communicator circuitry to receive a plurality of job execution requests, each job execution request including a job requested to be accelerated received from an orchestrator server; job analyzer circuitry to determine one or more job parameters of each requested job based on the corresponding job execution request accelerator manager circuitry to select an accelerator device of the compute device to execute each job based at least in part on the job parameters of the corresponding job; and kernel parameter determiner circuitry to determine, for each job, whether one or more kernels are to be registered on the corresponding accelerator device selected for the corresponding job to enable the corresponding accelerator device to execute the job; kernel registerer circuitry to register, in response to a determination that the one or more kernels are to be registered, the one or more kernels on the corresponding accelerator device; and kernel scheduler circuitry to schedule, for each accelerator device of the compute device, the kernels of the corresponding accelerator device based on a kernel prediction.

Example 62 includes the subject matter of Example 61, and wherein to determine whether one or more kernels are to be registered on the corresponding accelerator device comprises to determine whether each kernel associated with a corresponding requested job has been previously registered on the compute device.

Example 63 includes the subject matter of any of Examples 61 and 62, and wherein each of the plurality of the accelerator devices is a field programmable gate array (FPGA) and wherein to register the one or more kernels on the corresponding accelerator device comprises to register the one or more kernels on the corresponding FPGA and determine one or more kernel parameters of each kernel.

Example 64 includes the subject matter of any of Examples 61-63, and wherein to determine the one or more kernel parameters of each kernel comprises to determine an application identification (ID) of an application requesting the requested job to be accelerated.

Example 65 includes the subject matter of any of Examples 61-64, and wherein to determine the one or more kernel parameters of each kernel comprises to determine a kernel identification (ID) of each kernel.

Example 66 includes the subject matter of any of Examples 61-65, and wherein to determine the one or more kernel parameters of each kernel comprises to determine a bit-stream.

Example 67 includes the subject matter of any of Examples 61-66, and wherein to determine the one or more kernel parameters of each kernel comprises to determine an estimated runtime of each kernel based on one or more previous executions of each kernel.

Example 68 includes the subject matter of any of Examples 61-67, and wherein to determine the one or more kernel parameters of each kernel comprises to determine one or more previous timestamps of each kernel.

Example 69 includes the subject matter of any of Examples 61-68, and wherein to determine the one or more job parameters of each requested job based on the corresponding job execution request comprises to determine a kernel identification (ID) of the kernel associated with each requested job.

Example 70 includes the subject matter of any of Examples 61-69, and wherein to determine the one or more job parameters of each requested job based on the corresponding job execution request comprises to determine a payload of each requested job.

Example 71 includes the subject matter of any of Examples 61-70, and wherein to determine the one or more job parameters of each requested job based on the corresponding job execution request comprises to determine an estimated runtime of each requested job.

Example 72 includes the subject matter of any of Examples 61-71, and wherein to determine the estimated runtime of each requested job comprises to determine an estimated runtime of each requested job as a function of a payload size of the corresponding requested job.

Example 73 includes the subject matter of any of Examples 61-72, and wherein to determine the estimated runtime of the requested job comprises to determine an estimated runtime of each requested job as a function of previous runs of the corresponding requested job.

Example 74 includes the subject matter of any of Examples 61-73, and wherein to determine the estimated runtime of the requested job comprises to determine an estimated runtime of each requested job as a function of hints received from the job execution request.

Example 75 includes the subject matter of any of Examples 61-74, and wherein the hints comprise a usage pattern of one or more accelerator devices.

Example 76 includes the subject matter of any of Examples 61-75, and wherein to schedule the kernels registered on the accelerator devices of the compute device comprises to prioritize the kernels registered on the compute device based on the kernel prediction.

Example 77 includes the subject matter of any of Examples 61-76, and wherein to prioritize the kernels registered on the compute device based on the kernel prediction comprises to prioritize the kernels based on an estimated runtime of each kernel.

Example 78 includes the subject matter of any of Examples 61-77, and wherein to prioritize the kernels based on the estimated runtime of each kernel comprises to prioritize a kernel with a shorter execution time before a kernel with a longer execution time.

Example 79 includes the subject matter of any of Examples 61-78, and wherein to prioritize the kernels registered on the compute device based on the kernel prediction comprises to prioritize the kernels based on a past execution history of each kernel.

Example 80 includes the subject matter of any of Examples 61-79, and wherein to prioritize the kernels registered on the compute device based on the kernel prediction comprises to prioritize a next most probable kernel to receive a job to be accelerated.

Example 81 includes the subject matter of any of Examples 61-80, and wherein the accelerator manager circuitry is further to monitor kernel submission and execution of each job execution request on a corresponding kernel.

Example 82 includes the subject matter of any of Examples 61-81, and wherein to monitor kernel submission and execution of each job execution request on the corresponding kernel comprises to update a timestamp of the kernel execution for the corresponding kernel.

Example 83 includes the subject matter of any of Examples 61-82, and wherein to monitor kernel submission and execution of each job execution request on the corresponding kernel comprises to transmit a status of the corresponding kernel to the orchestrator server.

Example 84 includes the subject matter of any of Examples 61-83, and wherein to transmit the status of the corresponding kernel to the orchestrator server comprises to transmit a notification that a queue of the corresponding kernel has satisfied a predefined threshold.

Example 85 includes the subject matter of any of Examples 61-84, and further including kernel predictor circuitry to predict a next probable kernel from the kernels registered on the accelerator devices of the compute device to receive a job to be accelerated based on an execution pattern of each kernel.

Example 86 includes the subject matter of any of Examples 61-85, and wherein to predict a next probable kernel from the kernels registered on the accelerator devices of the compute device comprises to predict an execution pattern of each kernel registered on the accelerator devices of the compute device for each application.

Example 87 includes the subject matter of any of Examples 61-86, and wherein to predict an execution pattern comprises to determine a past execution history of each kernel for each application.

Example 88 includes the subject matter of any of Examples 61-87, and wherein to predict an execution pattern comprises to predict patterns of the kernels with machine learning.

Example 89 includes the subject matter of any of Examples 61-88, and wherein to predict a next probable kernel comprises to determine a probability of each kernel being a next kernel to receive a job from one or more available applications.

Example 90 includes a compute device comprising circuitry for receiving a plurality of job execution requests, each job execution request including a job requested to be accelerated received from an orchestrator server; circuitry for determining one or more job parameters of each requested job based on the corresponding job execution request; means for selecting an accelerator device of the compute device to execute each job based at least in part on the job parameters of the corresponding job; means for determining, for each job, whether one or more kernels are to be registered on the corresponding accelerator device selected for the corresponding job to enable the corresponding accelerator device to execute the job; circuitry for registering, in response to a determination that the one or more kernels are to be registered, the one or more kernels on the corresponding accelerator device; and means for scheduling, for each accelerator device of the compute device, the kernels of the corresponding accelerator device based on a kernel prediction.

Example 91 includes the subject matter of Example 90, and wherein the means for determining whether one or more kernels are to be registered on the corresponding accelerator device comprises circuitry for determining whether each kernel associated with a corresponding requested job has been previously registered on the compute device.

Example 92 includes the subject matter of any of Examples 90 and 91, and wherein each of the plurality of the accelerator devices is a field programmable gate array (FPGA) and wherein the circuitry for registering the one or more kernels on the corresponding accelerator device comprises circuitry for register the one or more kernels on the corresponding FPGA and circuitry for determining one or more kernel parameters of each kernel.

Example 93 includes the subject matter of any of Examples 90-92, and wherein the means for determining the one or more kernel parameters of each kernel comprises circuitry for determining an application identification (ID) of an application requesting the requested job to be accelerated.

Example 94 includes the subject matter of any of Examples 90-93, and wherein the circuitry for determining the one or more kernel parameters of each kernel comprises circuitry for determining a kernel identification (ID) of each kernel.

Example 95 includes the subject matter of any of Examples 90-94, and wherein the circuitry for determining the one or more kernel parameters of each kernel comprises circuitry for determining a bit-stream.

Example 96 includes the subject matter of any of Examples 90-95, and wherein the circuitry for determining the one or more kernel parameters of each kernel comprises circuitry for determining an estimated runtime of each kernel based on one or more previous executions of each kernel.

Example 97 includes the subject matter of any of Examples 90-96, and wherein the circuitry for determining the one or more kernel parameters of each kernel comprises circuitry for determining one or more previous timestamps of each kernel.

Example 98 includes the subject matter of any of Examples 90-97, and wherein the circuitry for determining the one or more job parameters of each requested job based on the corresponding job execution request comprises determining circuitry for a kernel identification (ID) of the kernel associated with each requested job.

Example 99 includes the subject matter of any of Examples 90-98, and wherein the circuitry for determining the one or more job parameters of each requested job based on the corresponding job execution request comprises circuitry for determining a payload of each requested job.

Example 100 includes the subject matter of any of Examples 90-99, and wherein the circuitry for determining the one or more job parameters of each requested job based on the corresponding job execution request comprises circuitry for determining an estimated runtime of each requested job.

Example 101 includes the subject matter of any of Examples 90-100, and wherein the circuitry for determining the estimated runtime of each requested job comprises circuitry for determining an estimated runtime of each requested job as a function of a payload size of the corresponding requested job.

Example 102 includes the subject matter of any of Examples 90-101, and wherein the circuitry for determining the estimated runtime of the requested job comprises circuitry for determining an estimated runtime of each requested job as a function of previous runs of the corresponding requested job.

Example 103 includes the subject matter of any of Examples 90-102, and wherein the circuitry for determining the estimated runtime of the requested job comprises circuitry for determining an estimated runtime of each requested job as a function of hints received from the job execution request.

Example 104 includes the subject matter of any of Examples 90-103, and wherein the hints comprise a usage pattern of one or more accelerator devices.

Example 105 includes the subject matter of any of Examples 90-104, and wherein the means for scheduling the kernels registered on the accelerator device of the compute device comprises circuitry for prioritizing the kernels registered on the compute device based on the kernel prediction.

Example 106 includes the subject matter of any of Examples 90-105, and wherein the circuitry for prioritizing the kernels registered on the compute device based on the kernel prediction comprises circuitry for prioritizing the kernels based on an estimated runtime of each kernel.

Example 107 includes the subject matter of any of Examples 90-106, and wherein the circuitry for prioritizing the kernels based on the estimated runtime of each kernel comprises circuitry for prioritizing a kernel with a shorter execution time before a kernel with a longer execution time.

Example 108 includes the subject matter of any of Examples 90-107, and wherein the circuitry for prioritizing the kernels registered on the compute device based on the kernel prediction comprises circuitry for prioritizing the kernels based on a past execution history of each kernel.

Example 109 includes the subject matter of any of Examples 90-108, and wherein the circuitry for prioritizing the kernels registered on the compute device based on the kernel prediction comprises circuitry for prioritizing a next most probable kernel to receive a job to be accelerated.

Example 110 includes the subject matter of any of Examples 90-109, and further including circuitry for monitoring, by the compute device, kernel submission and execution of each job execution request on a corresponding kernel.

Example 111 includes the subject matter of any of Examples 90-110, and wherein the circuitry for monitoring kernel submission and execution of each job execution request on the corresponding kernel comprises circuitry for updating a timestamp of the kernel execution for the corresponding kernel.

Example 112 includes the subject matter of any of Examples 90-111, and wherein the circuitry for monitoring kernel submission and execution of each job execution request on the corresponding kernel comprises circuitry for transmitting a status of the corresponding kernel to the orchestrator server.

Example 113 includes the subject matter of any of Examples 90-112, and wherein the circuitry for transmitting the status of the corresponding kernel to the orchestrator server comprises circuitry for transmitting a notification that a queue of the corresponding kernel has satisfied a predefined threshold.

Example 114 includes the subject matter of any of Examples 90-113, and further including circuitry for predicting, by the compute device, a next probable kernel from the kernels registered on the accelerator devices of the compute device to receive a job to be accelerated based on an execution pattern of each kernel.

Example 115 includes the subject matter of any of Examples 90-114, and wherein the circuitry for predicting a next probable kernel from the kernels registered on the accelerator devices of the compute device comprises circuitry for predicting an execution pattern of each kernel registered on the accelerator devices of the compute device for each application.

Example 116 includes the subject matter of any of Examples 90-115, and wherein the circuitry for predicting an execution pattern comprises circuitry for determining a past execution history of each kernel for each application.

Example 117 includes the subject matter of any of Examples 90-116, and wherein the circuitry for predicting an execution pattern comprises circuitry for predicting patterns of the kernels with machine learning.

Example 118 includes the subject matter of any of Examples 90-117, and wherein the circuitry for predicting a next probable kernel comprises circuitry for determining a probability of each kernel being a next kernel to receive a job from one or more available applications.

1. A compute device comprising:
a plurality of accelerator devices; and
a management logic unit to:
receive a plurality of job execution requests, each job execution request including a job requested to be accelerated received from an orchestrator server;
determine one or more job parameters of each requested job based on the corresponding job execution request;
select an accelerator device of the compute device to execute each job based at least in part on the job parameters of the corresponding job;
determine, for each job, whether one or more kernels are to be registered on the corresponding accelerator device selected for the corresponding job to enable the corresponding accelerator device to execute the job;
register, in response to a determination that the one or more kernels are to be registered, the one or more kernels on the corresponding accelerator device; and
schedule, for each accelerator device of the compute device, the kernels of the corresponding accelerator device based on a kernel prediction.

2. The compute device of claim 1, wherein to determine whether one or more kernels are to be registered on the corresponding accelerator device comprises to determine whether each kernel associated with a corresponding requested job has been previously registered on the compute device.

3. The compute device of claim 1, wherein each of the plurality of the accelerator devices is a field programmable gate array (FPGA) and wherein to register the one or more kernels on the corresponding accelerator device comprises to register the one or more kernels on the corresponding FPGA and determine one or more kernel parameters of each kernel.

4. The compute device of claim 3, wherein to determine the one or more kernel parameters of each kernel comprises to determine an application identification (ID) of an application requesting the requested job to be accelerated, a kernel identification (ID) of each kernel, a bit-stream, an estimated runtime of each kernel based on one or more previous executions of each kernel, and/or one or more previous timestamps of each kernel.

5. The compute device of claim 1, wherein to determine the one or more job parameters of each requested job based on the corresponding job execution request comprises to determine a kernel identification (ID) of the kernel associated with each requested job.

6. The compute device of claim 1, wherein to determine the one or more job parameters of each requested job based on the corresponding job execution request comprises to determine a payload of each requested job.

7. The compute device of claim 1, wherein to determine the one or more job parameters of each requested job based on the corresponding job execution request comprises to determine an estimated runtime of each requested job.

8. The compute device of claim 1, wherein to schedule the kernels registered on the accelerator device of the compute device comprises to prioritize the kernels registered on the compute device based on the kernel prediction.

9. The compute device of claim 8, wherein to prioritize the kernels registered on the compute device based on the kernel prediction comprises to prioritize the kernels based on an estimated runtime of each kernel or a past execution history of each kernel.

10. The compute device of claim 8, wherein to prioritize the kernels registered on the compute device based on the kernel prediction comprises to prioritize a next most probable kernel to receive a job to be accelerated.

11. The compute device of claim 1, wherein the management logic unit is further to predict a next probable kernel from the kernels registered on the accelerator devices of the compute device to receive a job to be accelerated based on an execution pattern of each kernel.

12. The compute device of claim 11, wherein to predict a next probable kernel from the kernels registered on the accelerator devices of the compute device comprises to predict an execution pattern of each kernel registered on the accelerator devices of the compute device for each application.

13. One or more machine-readable storage media comprising a plurality of instructions stored thereon that, when executed by a compute device cause the compute device to:
receive a plurality of job execution requests, each job execution request including a job requested to be accelerated received from an orchestrator server;
determine one or more job parameters of each requested job based on the corresponding job execution request;
select an accelerator device of the compute device to execute each job based at least in part on the job parameters of the corresponding job;
determine, for each job, whether one or more kernels are to be registered on the corresponding accelerator device selected for the corresponding job to enable the corresponding accelerator device to execute the job;
register, in response to a determination that the one or more kernels are to be registered, the one or more kernels on the corresponding accelerator device; and
schedule, for each accelerator device of the compute device, the kernels of the corresponding accelerator device based on a kernel prediction.

14. The one or more machine-readable storage media of claim 13, wherein to determine whether one or more kernels are to be registered on the corresponding accelerator device comprises to determine whether each kernel associated with a corresponding requested job has been previously registered on the compute device.

15. The one or more machine-readable storage media of claim 13, wherein each of the plurality of the accelerator devices is a field programmable gate array (FPGA) and wherein to register the one or more kernels on the corresponding accelerator device comprises to register the one or more kernels on the corresponding FPGA and determine one or more kernel parameters of each kernel.

16. The one or more machine-readable storage media of claim 15, wherein to determine the one or more kernel parameters of each kernel comprises to determine an application identification (ID) of an application requesting the requested job to be accelerated, a kernel identification (ID) of each kernel, a bit-stream, an estimated runtime of each kernel based on one or more previous executions of each kernel, and/or one or more previous timestamps of each kernel.

17. The one or more machine-readable storage media of claim 13, wherein to determine the one or more job parameters of each requested job based on the corresponding job execution request comprises to determine a kernel identification (ID) of the kernel associated with each requested job.

18. The one or more machine-readable storage media of claim 13, wherein to determine the one or more job parameters of each requested job based on the corresponding job execution request comprises to determine a payload of each requested job.

19. The one or more machine-readable storage media of claim 13, wherein to determine the one or more job parameters of each requested job based on the corresponding job execution request comprises to determine an estimated runtime of each requested job.

20. The one or more machine-readable storage media of claim 13, wherein to schedule the kernels registered on the accelerator device of the compute device comprises to prioritize the kernels registered on the compute device based on the kernel prediction.

21. The one or more machine-readable storage media of claim 20, wherein to prioritize the kernels registered on the compute device based on the kernel prediction comprises to prioritize the kernels based on an estimated runtime of each kernel or a past execution history of each kernel.

22. The one or more machine-readable storage media of claim 20, wherein to prioritize the kernels registered on the compute device based on the kernel prediction comprises to prioritize a next most probable kernel to receive a job to be accelerated.

23. The one or more machine-readable storage media of claim 13, wherein the plurality of instructions, when executed, further cause the compute device to predict a next probable kernel from the kernels registered on the accelerator devices of the compute device to receive a job to be accelerated based on an execution pattern of each kernel.

24. The one or more machine-readable storage media of claim 23, wherein to predict a next probable kernel from the kernels registered on the accelerator devices of the compute device comprises to predict an execution pattern of each kernel registered on the accelerator devices of the compute device for each application.

25. A compute device comprising:
circuitry for receiving a plurality of job execution requests, each job execution request including a job requested to be accelerated received from an orchestrator server;
circuitry for determining one or more job parameters of each requested job based on the corresponding job execution request;
means for selecting an accelerator device of the compute device to execute each job based at least in part on the job parameters of the corresponding job;
means for determining, for each job, whether one or more kernels are to be registered on the corresponding accelerator device selected for the corresponding job to enable the corresponding accelerator device to execute the job;
circuitry for registering, in response to a determination that the one or more kernels are to be registered, the one or more kernels on the corresponding accelerator device; and
means for scheduling, for each accelerator device of the compute device, the kernels of the corresponding accelerator device based on a kernel prediction.

26. A method for overprovisioning accelerator devices of a compute device, the method comprising:
receiving, by the compute device, a plurality of job execution requests, each job execution request including a job requested to be accelerated received from an orchestrator server;
determining, by the compute device, one or more job parameters of each requested job based on the corresponding job execution request;
selecting, by the compute device, an accelerator device of the compute device to execute each job based at least in part on the job parameters of the corresponding job;
determining, by the compute device and for each job, whether one or more kernels are to be registered on the corresponding accelerator device selected for the corresponding job to enable the corresponding accelerator device to execute the job;
registering, by the compute device and in response to a determination that the one or more kernels are to be registered, the one or more kernels on the corresponding accelerator device; and
scheduling, for each accelerator device of the compute device and by the compute device, the kernels of the corresponding accelerator device based on a kernel prediction.

27. The method of claim 26, wherein scheduling the kernels registered on the accelerator device of the compute device comprises prioritizing the kernels registered on the compute device based on the kernel prediction.

28. The method of claim 26, further comprising predicting, by the compute device, a next probable kernel from the kernels registered on the accelerator devices of the compute device to receive a job to be accelerated based on an execution pattern of each kernel.
